(19) United States
(12) Patent Application Publication
(10) Pub. No.: US 2018/0186944 A1
(43) Pub. Date: Jul. 5, 2018

(54) Crosslinking of Polyamides in the Melt

(71) Applicant: BASF SE, Ludwigshafen (DE)

(72) Inventors: Gijsbrecht Jacobus Maria Habraken, Ludwigshafen (DE); Johannes Klaus Sprafke, Speyer (DE); Marion da Silva, Ludwigshafen (DE); Martin Alexander Bohn, Mannheim (DE); Monika Charrak, Bobenheim-Roxheim (DE)

(21) Appl. No.: 15/740,019

(22) PCT Filed: Jul. 6, 2016
(86) PCT No.: PCT/EP2016/066032

§ 371 Date: Dec. 27, 2017

(30) Foreign Application Priority Data
Jul. 9, 2015 (EP) 15176123.6

(51) Int. Cl. C08J 3/24; C08G 69/26; C08G 69/48

(52) U.S. Cl. CPC C08J 3/246; C08L 57/12; C08G 69/48; C08G 69/26

(57) ABSTRACT

The present invention relates to a process for preparing a crosslinked polyamide (vP) by providing a melt (S), which comprises at least one polyamide (P) containing furan units and at least one dienophile at a first temperature T₁, and cooling the melt (S) subsequently to a second temperature T₂ which is below the melting temperature T_{M} of the at least one polyamide (P), to give the crosslinked polyamide (vP). The present invention further relates to a crosslinked polyamide (vP) obtainable by the process of the invention.

The present invention relates to a process for preparing a crosslinked polyamide (vP) by providing a melt (S), which comprises at least one polyamide (P) containing furan units and at least one dienophile at a first temperature T₁, and cooling the melt (S) subsequently to a second temperature T₂ which is below the melting temperature T_{M} of the at least one polyamide (P), to give the crosslinked polyamide (vP). The present invention further relates to a crosslinked polyamide (vP) obtainable by the process of the invention.

Polyamides in general are semicrystalline polymers which are of particular importance industrially on account of their very good mechanical properties. In particular they possess high strength, stiffness, and toughness, good chemical resistance, and a high abrasion resistance and tracking resistance. These properties are particularly important for the production of injection moldings. High toughness is particularly important for the use of polyamides as packaging films. On account of their mechanical properties, polyamides are used industrially for producing textiles such as fishing lines, climbing ropes, and carpeting. Polyamides also find use for the production of wall plugs, screws, and cable ties. Polyamides, furthermore, are employed as paints, adhesives, and coating materials.

In order to prepare polyamides which are particularly stable chemically and mechanically, polyamides are subjected, for example, to crosslinking. There are a variety of techniques described in the prior art for the crosslinking of polyamides.

For example, in the production of polyamides, it is possible to use monomers with a degree of functionalization of three or more, causing the resulting polyamides to crosslink. A disadvantage with this method, however, is that the crosslinked polyamides produced in this way cannot be further-processed by the usual processing techniques of injection molding and extrusion, since the polyamides, when melted, continue to react, through transamidation, and alter their properties as a result.

A further variant of polyamide crosslinking involves crosslinking components of polyamide by gamma radiation after they have been produced. A disadvantage here is that the crosslinking is irreversible and the polyamides therefore can no longer be further-processed and, for example, reshaped. Moreover, the additional processing step increases the costs and the logistical outlay.

Described in the prior art are various processes for providing polymers, especially polyesters and also polyamides, which can be reversibly crosslinked in order to ensure their further processing. Such polymers are also termed functional polymers.

For example, dienes and dienophiles can be installed into the side chains of polymers, these species being capable of joining adjacent chains to one another via a Diels-Alder reaction and so crosslinking.

One disadvantage of using dienes and dienophiles in the side chains of a polymer is that it is through the side chains that the mechanical properties of the polymer are modified. Moreover, the side chains modify the glass transition temperature T_{G} of the polymer and reduce its crystallinity. Another problem with the use of dienes and dienophiles alongside one another in the side chains of the polymers is seen as being that the dienes under certain circumstances enter into unwanted reactions with the dienophiles, as for example under shearing, as a result of which the properties of the polymer may alter. The introduction of dienes and dienophiles into the side chains, furthermore, is frequently associated with increased synthesis work and hence higher costs.

There is therefore a need for processes which allow crosslinked polymers to be produced, especially crosslinked polyamides, which do not have the disadvantages described above, or have them to a reduced extent.

The object on which the present invention is based is therefore that of providing a process for preparing crosslinked polyamides that do not have, or that have to a reduced extent, the above-described disadvantages of the prior-art processes for the preparation of crosslinked polyamides. The process, moreover, ought to be able to be carried out as simply and inexpensively as possible.

This object is achieved by means of a process for preparing a crosslinked polyamide (vP), comprising the steps of
i) providing a melt (S) which comprises components
   A) at least one polyamide (P) having a melting temperature T_{M} and comprising diene units of the general formula (I)

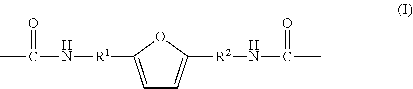

in which
R¹ and R² independently of one another are selected from C₁-C₁₀ alkanediyl,
B) at least one dienophile which comprises at least two dienophile units which are reactive toward the diene units present in component A),
at a first temperature T₁ which is above the melting temperature T_{M} of component A),
ii) cooling the melt (S) to a second temperature T₂ which is below the melting temperature T_{M} of component A), to give the crosslinked polyamide (vP).

A feature of the process of the invention is its ease of implementation. Through the process of the invention it is possible to tailor the degree of crosslinking of the crosslinked polyamide (vP) obtained and so to influence the properties of the material in a very targeted and controlled manner.

Since the process of the invention is carried out in a melt, there is no need for a solvent to be used. The crosslinked polyamide therefore contains no solvent-derived impurities, this being a particular advantage for the further processing of the crosslinked polyamide (vP).

Since the crosslinking of the crosslinked polyamide (vP) is reversible, the crosslinked polyamide (vP) can be melted again and, for example, reshaped.

The crosslinked polyamide (vP) prepared in accordance with the invention possesses, moreover, a greater stiffness, more particularly a relatively high modulus of elasticity and a relatively high yield stress, and also a higher breaking stress, than uncrosslinked polyamides.

The process of the invention is elucidated in more detail below.

Step i)

In step i) a melt is provided which comprises as component A) at least one polyamide (P) having a melting temperature T_{M} and as component B) at least one dienophile, at a first temperature T₁ which is above the melting temperature T_{M} of component A).

The melt (S) contains customarily in the range from 85 to 99.5 wt %, preferably in the range from 90 to 99 wt %, and especially preferably in the range from 95 to 99 wt % of component A), based on the sum of the weight percentages of components A) and B), preferably based on the total weight of the melt (S).

The melt (S) contains customarily in the range from 0.5 to 15 wt %, preferably in the range from 1 to 10 wt %, and especially preferably in the range from 1 to 5 wt % of component B), based in each case on the sum of the weight percentages of components A) and B), preferably based on the total weight of the melt (S).

In one embodiment of the invention the melt (S) further comprises as component C) at least one endgroup regulator.

Customarily the melt (S) further comprises as component C) in the range from 0 to 2 wt %, preferably in the range from 0.1 to 1.5 w %, and especially preferably in the range from 0.2 to 1 wt % of at least one endgroup regulator, based in each case on the sum of the weight percentages of the components A), B), and C) present in the melt (S), preferably based on the total weight of the melt (S).

The present invention accordingly also provides a process wherein the melt (S) further comprises as component C) in the range from 0 to 2 wt % of at least one endgroup regulator, based on the sum of the wt % of the components A), B), and C) present in the melt (S).

In a further embodiment the melt (S) further comprises as component D) at least one radical scavenger.

Customarily the melt (S) further comprises as component D) in the range from 0.1 to 5 wt %, preferably in the range from 0.2 to 4 wt %, and especially preferably in the range from 0.5 to 3 wt % of at least one radical scavenger, based on the total weight of the components A), B), C), and D) present in the melt (S), preferably based on the total weight of the melt (S).

The present invention accordingly also provides a process wherein the melt (S) further comprises as component D) in the range from 0.5 to 5 wt % of at least one radical scavenger, based on the total weight of the components A), B), C), and D present in the melt (S).

The above-specified weight percentages are based on the components A) and B) and also, optionally, C) and D) that are present in the melt (S), preferably on the total weight of the melt (S). Where the melt (S) contains only components A) and B), the weight percentages are based on the sum of the weight percentages of components A) and B). Where the melt (S) additionally includes component C), the weight percentages are based on the sum of the weight percentages of components A), B), and C). Where the melt (S) further contains component D), the weight percentages are based on the sum of the weight percentages of components A), B), and D). Where the melt (S) additionally comprises both components C) and D), the weight percentages are based on the sum of the weight percentages of components A), B), C), and D). Preferably the weight percentages are based in each case on the total weight of the melt (S).

All the wt % figures relating to the components A) and B) and also, optionally C) and D) that are present in the melt (S) are based, unless otherwise indicated, on the melt (S) before a reaction between components A) and B) and also, optionally C) and D), takes place more particularly before the crosslinked polymer (vP) is obtained in step ii).

It is self-evident that if the melt (S) further comprises the components C) and D), the melt (S) contains a correspondingly lower fraction of the components A) and B).

In one embodiment of the invention the melt (S) comprises components
A) at least one polyamide (P) having a melting temperature T_{M} and containing diene units of the general formula (I),
B) at least one dienophile which contains at least two dienophile units which are reactive toward the diene units present in component A),
C) at least one endgroup regulator,
D) at least one radical scavenger.

In one preferred embodiment the melt (S) contains from 83 to 99 wt %, preferably from 89.5 to 97.9 wt %, and especially preferably from 92 to 97.8 wt % of component A), from 0.5 to 10 wt %, preferably from 1 to 8 wt %, and especially preferably from 1 to 6 wt % of component B), from 0 to 2 wt %, preferably from 0.1 to 1.5 wt %, and especially preferably from 0.2 to 1 wt % of component C), and from 0.1 to 5 wt %, preferably from 0.2 to 4 wt %, and especially preferably from 0.5 to 3 wt % of component D), based in each case on the sum of the weight percentages of components A) to D), preferably based on the total weight of the melt (S).

The present invention accordingly also provides a process wherein the melt (S) comprises the following components:
A) from 83 to 99 wt % of component A),
B) from 0.5 to 10 wt % of component B),
C) from 0 to 2 wt % of at least one endgroup regulator,
D) from 0.1 to 5 wt % of at least one radical scavenger,

based in each case on the sum of the wt % of the components A) to D) present in the melt (S).

In one embodiment the melt (S) is substantially free from solvents. The solvents are different from components A), B), C), and D). The melt (S) is preferably substantially free from solvents selected from the group consisting of lactams, toluene, hexafluoroisopropanol, tetrahydrofuran, water, concentrated acids such as sulfuric acid, formic acid, trifluoroacetic acid, chloroacetic acid, aromatic alcohols such as phenylethyl alcohol, benzyl alcohol, phenols, but also cresols, glycols, trifluoroethanol, and mixtures thereof. Most preferably the melt (S) is substantially free from solvents capable of dissolving polyamides.

“Substantially free from solvents” means in the present context that the melt (S) contains less than 5 wt %, preferably less than 2 wt %, and especially preferably less than 1 wt % of solvent, based in each case on the total weight of the melt (S).

In step i) the melt (S) is provided by the first temperature T₁.

The melt (S) can be provided in accordance with all of the methods known to the skilled person. For example the melt (S) can be provided by jointly melting the components A), B), and also, optionally, C) and D). A further possibility is for at least one of the components A), B) or optionally C) or D) to be melted and for the other components to be subsequently added. For example it is possible first to melt component A) and then to supply component B) and also, optionally, components C) and D). Preferably first of all component A) is melted, then optionally components C) and D) are added, and lastly component B) is supplied.

The melt (S) may be provided in any vessels which can be heated to the first temperature T₁ and which are suitable for the keeping of liquids, more particularly of polymer melts. Suitable reactors are, for example, stirred tank reactors, kneading reactors, or extruders. The melt (S) is preferably provided in an extruder.

Extruders as such are known to the skilled person. The extruder may for example comprise static and/or dynamic mixing elements. Static and dynamic mixing elements are known to the skilled person.

The first temperature T₁ at which the melt (S) is provided in step i) is above the melting temperature T_{M} of component A). Customarily the first temperature T₁ is at least 1° C., preferably at least 5° C., and especially preferably at least 10° C. above the melting temperature T_{M} of component A).

“Melting temperature T_{M}” refers to the temperature at which or above which the polyamide (P) is present completely in the liquid aggregate state. The melting temperature is determined here in pure substance. The melting temperature T_{M} is determined by differential scanning calorimetry (DSC) or by dynamic mechanical thermoanalysis (DMTA) for semicrystalline polyamides. For amorphous polyamides, T_{M} is defined as the temperature at which the polyamide (P) (having a minimum solution viscosity of 80 mL/g to ISO307 in sulfuric acid) has at least a zero shear viscosity of 5000 Pa s and hence is processible in the melt (measured on a DHR-1 rotational rheometer from TA Instruments, plate/plate geometry, plate diameter 25 mm and sample height 1.0 mm. Deformation 1.0%, preheat time 1.5 min, and material dried under reduced pressure at 80° C. for 7 days beforehand).

Component A) generally has a decomposition temperature above which the at least one polyamide (P) decomposes. The first temperature T₁ is customarily at least 1° C., preferably at least 5° C., and especially preferably at least 10° C. below the decomposition temperature of component A).

“Decomposition temperature” refers to the temperature at which or above which the polyamide (P) exhibits a reduction in molecular weight by thermal cleavage. The decomposition temperature here is determined in pure substance. The decomposition may be measured by thermogravimetric analysis, decrease in viscosity number, or discoloration of the polyamide (P). Methods for this are known to the skilled person.

The first temperature T₁ is customarily in the range from 90 to 380° C., preferably in the range from 160 to 290° C., and especially preferably in the range from 190 to 270° C.

The present invention accordingly also provides a process wherein the first temperature T₁ in step i) is in the range from 90 to 380° C.

In the melt (S) provided in step i), component A) is in melted form. Components B) and also, optionally, C) and D) are present in solution in component A). The components B) and also, optionally, C) and D) may likewise be present in melted form and in solution in component A).

Hereinafter the components present in the melt (S) are described in more detail.

Component A)

As component A) the melt (S) comprises at least one polyamide (P) having a melting temperature T_{M}, comprising furan units as repeating units of the general formula (I)

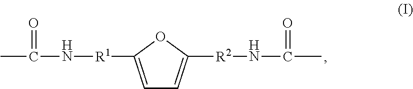

in which R¹ and R² have the definitions described above.

The furan units as repeating units of the general formula (I) are present preferably in the main chain of the at least one polyamide (P). Especially preferably the at least one polyamide (P) contains no side chains which comprise furan units as repeating units of the general formula (I), and most preferably the at least one polyamide (P) contains no side chains. The at least one polyamide (P) is therefore most preferably at least one linear polyamide (P).

The furan units are also referred to as diene units. These terms are used synonymously in accordance with the invention.

In one preferred embodiment R¹ and R² in the general formula (I) have the definitions below.

R¹ and R² are selected independently of one another from C₁-C₄ alkanediyl,

preferably R¹ and R² are the same C₁-C₄ alkanediyl, and

most preferably in the general formula (I)

R¹ and R² are both methylene.

“C₁-C₁₀ alkanediyl” as described for example above for R¹ and R² for the at least one polyamide (P) of the general formula (I) means in the context of the present invention a hydrocarbon having 1 to 10 carbon atoms and two free valences. It is therefore a biradical having 1 to 10 carbon atoms. “C₁-C₁₀ alkanediyl” encompasses both linear and cyclic, and also saturated and unsaturated, hydrocarbons having 1 to 10 carbon atoms and two free valences. Hydrocarbons having a cyclic fraction and a linear fraction are likewise included by the term “C₁-C₁₀ alkanediyl”. Examples of C₁-C₁₀ alkanediyls are methylene, ethylene (ethane-1,2-diyl, dimethylene), propane-1,3-diyl (trimethylene), propylene (propane-1,2-diyl), and butane-1,4-diyl (tetramethylene). Corresponding observations apply in respect of “C₁-C₄ alkanediyl”.

“At least one polyamide (P)” in the context of the present invention means not only exactly one polyamide (P) but also a mixture of two or more polyamides (P).

The at least one polyamide (P) may be prepared by any methods known to the skilled person.

In one preferred embodiment the at least one polyamide (P) is prepared by polymerization from a reaction mixture (RM) at a reaction temperature T_{R}, the reaction mixture (RM) comprising the components below.
A1) at least one lactam
A2) at least one diamine of the general formula (II)

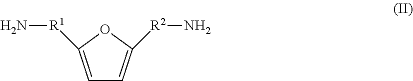

in which
R¹ and R² independently of one another are selected from C₁-C₁₀ alkanediyl,
A3) at least one dicarboxylic acid derivative selected from the group consisting of a dicarboxylic acid of the general formula (III), a dicarboxylic ester of the general formula (IV), and a dinitrile of the general formula (V)

HOOC—R³—COOH (III)

R⁵OOC—R⁴—COOR⁶ (IV)

NC—R⁷—CN (V)
in which
R³, R⁴ and R⁷ independently of one another are selected from the group consisting of a bond, unsubstituted or at least monosubstituted C₁-C₄₀ alkanediyl, and unsubstituted or at least monosubstituted C₆-C₄₀ arylene, where
   the substituents are selected from the group consisting of F, Cl, Br, I, OR⁸, C₁-C₁₀ alkyl, and C₆-C₁₀ aryl, where
   R⁸ is selected from the group consisting of H and C₁-C₁₀ alkyl;
R⁵ and R⁶ independently of one another are selected from the group consisting of unsubstituted or at least monosubstituted C₁-C₂₀ alkyl, unsubstituted or at least monosubstituted C₆-C₂₀ aryl, and unsubstituted or at least monosubstituted C₆-C₂₀ aralkyl, where
   the substituents are selected from the group consisting of F, Cl, Br, I, OR⁹, and C₁-C₁₀ alkyl, where
   R⁹ is selected from the group consisting of H and C₁-C₁₀ alkyl; and
A4) water.

The reaction mixture (RM) comprises as component A1) at least one lactam, as component A2) at least one diamine (II), as component A3) at least one dicarboxylic acid derivative, selected from the group consisting of a dicarboxylic acid (III), a dicarboxylic ester (IV), and a dinitrile (V), as component A4) water, and optionally, as component A5), from 0 to 5 wt % of at least one endgroup regulator, based on the total weight of components A1) to A5).

In one embodiment of the present invention the reaction mixture (RM) comprises as component A1) in the range from 26 to 98 wt % of at least one lactam, as component A2) in the range from 0.5 to 35 wt % of at least one diamine (II), as component A3) in the range from 0.5 to 30 wt % of at least one dicarboxylic acid derivative, as component A4) in the range from 1 to 30 wt % of water, and as component A5) in the range from 0 to 1 wt % of at least one endgroup regulator, the weight percentages being based in each case on the total weight of components A1) to A4) or based on the total weight of components A1) to A5) in the event that the reaction mixture (RM) includes the component A5).

In accordance with the invention the wt % figures of components A1), A2), A3), A4) and, optionally, of component A5) are based on the total weight of the components A1), A2), A3), A5) and optionally, component A5) present in the reaction mixture (RM).

Where component A5) is not included in the reaction mixture (RM), the wt % figures of components A1), A2), A3), and A4) are based on the total weight of the components A1), A2), A3), and A4) present in the reaction mixture (RM).

In the event that component A5) is included in the reaction mixture (RM), the wt % figures of components A1), A2), A3), A4), and A5) are based on the total weight of the components A1), A2), A3), A4), and A5) present in the reaction mixture (RM).

In one preferred embodiment the wt % figures of components A1), A2), A3), A4) and, optionally, of component A5) are based on the total weight of the reaction mixture (RM).

In one embodiment of the present invention the reaction mixture (RM) therefore comprises

26 to 98 wt % of component A1),

0.5 to 35 wt % of component A2),

0.5 to 30 wt % of component A3), and

1 to 30 wt % of component A4),

the weight percentages being based in each case on the total weight of components A1) to A4) or based on the total weight of components A1) to A5), preferably based on the total weight of the reaction mixture (RM).

In one preferred embodiment of the present invention the reaction mixture (RM) comprises

50 to 89 wt % of component A1),

5 to 25 wt % of component A2),

5 to 25 wt % of component A3),

1 to 20 wt % of component A4), and

0.1 to 0.9 wt % of component A5),

the weight percentages being based in each case on the total weight of components A1) to A5), preferably based on the total weight of the reaction mixture (RM).

In one particularly preferred embodiment of the present invention the reaction mixture (RM) therefore comprises

75 to 82 wt % of component A1),

8 to 12 wt % of component A2),

8 to 13 wt % of component A3),

1 to 5 wt % of component A4), and

0.1 to 0.75 wt % of component A5),

the weight percentages being based in each case on the total weight of components A1) to A5), preferably based on the total weight of the reaction mixture (RM).

The sum of the weight percentages of the components A1) to A5) adds up in general to 100 wt %.

Unless otherwise indicated, all of the weight percent figures of the components A1) to A5) are based on the composition of the reaction mixture (RM) before the beginning of the polymerization. The phrase “composition of the reaction mixture (RM) before the beginning of the polymerization” refers in the context of the present invention to the composition of the reaction mixture (RM) before the components A1) to A5) present in the reaction mixture (RM) begin to react with one another, in other words before the polymerization sets in. The components A1) to A5) present in the reaction mixture (RM) are at that point therefore still in their unreacted form. It is self-evident that during the polymerization the components A1) to A5) present in the reaction mixture (RM) react at least partly with one another and therefore that the proportion of the components A1) to A5) among one another changes, and that the components A1) to A5) present in the reaction mixture (RM) change during the polymerization. The skilled person is aware of these reactions.

Lactam in accordance with the invention refers to cyclic amides which have 3 to 12 carbon atoms in the ring, preferably 6 to 12 carbon atoms. Suitable lactams are for example selected from the group consisting of 3-aminopropanolactam (β-lactam; β-propiolactam), 4-aminobutanolactam (γ-lactam; γ-butyrolactam), 5-amino-pentanolactam (β-lactam; β-valerolactam), 6-aminohexanolactam (ε-lactam; ε-caprolactam), 7-aminoheptanolactam (ζ-lactam; ζ-heptanolactam), 8-aminooctanolactam (η-lactam; η-octanolactam), 9-nonanolactam (θ-lactam; θ-nonanolactam), 10-decanolactam (ω-decanolactam), 11-undecanolactam (ω-undecanolactam), and 12-dodecanolactam (ω-dodecanolactam).

The lactams may be unsubstituted or at least monosubstituted. Where at least monosubstituted lactams are used, they may carry, on the carbon atoms of the ring, one, two or more substituents which are selected independently of one another from the group consisting of C₁ to C₁₀ alkyl, C₅ to C₆ cycloalkyl and C₅ to C₁₀ aryl.

Suitability as C₁ to C₁₀ alkyl substituents is possessed for example by methyl, ethyl, propyl, isopropyl, n-butyl, sec-butyl, and tert-butyl. An example of a suitable C₅ to C₆ cycloalkyl substituent is cyclohexyl. Preferred C₅ to C₁₀ aryl substituents are phenyl and anthranyl.

Preference is given to using unsubstituted lactams, in which case 12-dodecanolactam (ω-dodecanolactam) and ε-lactam (ε-caprolactam) are preferred. Particularly preferred is ε-lactam (ε-caprolactam).

ε-Caprolactam is the cyclic amide of caproic acid. It is also referred to as 6-aminohexanolactam, 6-hexanolactam or caprolactam. Its IUPAC name is “acepan-2-one”. Caprolactam possesses the CAS number 105-60-2 and the general formula C₆H₁₁NO. Processes for preparing caprolactam are known per se to the skilled person.

In one preferred embodiment component A2) is at least one diamine (II) in which R¹ and R² are selected independently of one another from C₁-C₄ alkanediyl.

More preferably component A2) is at least one diamine (II) in which R¹ and R² are the same C₁-C₄ alkanediyl.

Especially preferably component A2) is at least one diamine (II) in which R¹ and R² are both methylene.

If R¹ and R² are both methylene, the diamine (II) is 2,5-bis(aminomethyl)furan. 2,5-Bis(aminomethyl)furan has the CAS number 2213-51-6.

In one embodiment, moreover, the reaction mixture (RM) may further comprise at least one further diamine (component A2′)).

Suitable further diamines (component A2′)) are known per se to the skilled person. It is self-evident that the at least one further diamine (component A2′)) is different from component A2), the diamine (II). The at least one further diamine is preferably selected from alkanediamines having 4 to 36 carbon atoms, more particularly alkanediamines having 6 to 12 carbon atoms, and also aromatic diamines. With particular preference the at least one further diamine is selected from the group consisting of 1,4-butane-diamine, 1,5-pentanediamine, 1,6-hexamethylenediamine, 1,7-heptamethylenediamine, 1,8-octamethylenediamine, 1,9-nonanediamine, 1,10-decanediamine, 1,11-undecane-diamine, 1,12-dodecanediamine, 1,13-tridecanediamine, 1,14-tetradecanediamine, 1,15-pentadecanediamine, 1,16-hexadecanediamine, 1,17-heptadecanediamine, 1,18-octadecanediamine, C36-dimer diamine, bis(4-amino-3-methylcyclohexyl)methane (MACM), 4,4-methylenebis(cyclohexylamine) (PACM), bis(4-amino-3-ethyl-cyclohexyl)methane (EACM), bis(4-amino-3,5-dimethylcyclohexyl)methane (TMACM), isophoronediamine, m-xylylenediamine, p-xylylenediamine, 2,5-bis(methylamino)-tetrahydrofuran, 2,2-di(4-aminophenyl)propane, 2,2-di(4-aminocyclohexyl)propane, 2,4,4-trimethylhexamethylenediamine, and 1,5-diamino-2-methylpentane.

In one preferred embodiment the substituents of component A3) in the formula (III), the formula (IV), and the formula (V) have the following definitions:
R³, R⁴ and R⁷ are selected independently of one another from the group consisting of a bond, unsubstituted C₁-C₃₆ alkanediyl, and C₆-C₂₀ arylene;
R⁵ and R⁶ are selected independently of one another from the group consisting of unsubstituted C₁-C₁₀ alkyl, C₆-C₁₀ aryl, and C₆-C₁₂ aralkyl.

In one especially preferred embodiment the substituents in the formula (III), the formula (IV), and the formula (V) have the following definitions:
R³, R⁴ and R⁷ are selected independently of one another from the group consisting of a bond, unsubstituted C₁-C₁₂ alkanediyl, and C₆-C₁₀ arylene;
R⁵ and R⁶ are selected independently of one another from the group consisting of unsubstituted C₁-C₄ alkyl, C₁-C₁₀ aryl, and C₁-C₁₂ aralkyl.

“C₁-C₄₀ alkanediyl”, as described for R³ in formula (III), for example, is understood in the context of the present invention to refer to a hydrocarbon having two free valences and from 1 to 40 carbon atoms. Expressed otherwise, a C₁-C₄₀ alkanediyl is a biradical having 1 to 40 carbon atoms. “C₁-C₄₀ alkanediyl” encompasses both linear and cyclic, and also saturated and unsaturated, hydrocarbons having 1 to 40 carbon atoms and two free valences. Hydrocarbons which have both a linear and a cyclic component are likewise covered by the term. Corresponding statements apply in respect of C₁-C₃₆ alkanediyl and C₁-C₁₂ alkanediyl.

“C₆-C₄₀ arylene” refers to an aromatic hydrocarbon having two free valences and from 6 to 40 carbon atoms. Expressed otherwise, “C₆-C₄₀ arylene” refers to an aromatic biradical having 6 to 40 carbon atoms. A C₆-C₄₀ arylene therefore has an aromatic ring system. This ring system may be monocyclic, bicyclic or polycyclic. Corresponding statements apply in respect of C₆-C₂₀ arylene and C₆-C₁₀ arylene.

“C₁-C₂₀ alkyl” refers to saturated and unsaturated hydrocarbons having one free valence (radical) and from 1 to 20 carbon atoms. The hydrocarbons may be linear, branched or cyclic. It is also possible for them to comprise a cyclic component and a linear component. Examples of alkyl groups are methyl, ethyl, n-propyl, isopropyl, n-butyl, isobutyl, sec-butyl, tert-butyl, hexyl, and cyclohexyl. Corresponding statements also apply in respect of C₁-C₁₀ alkyl.

“C₆-C₂₀ aryl” denotes the radical of an aromatic hydrocarbon having 6 to 20 carbon atoms. An aryl therefore has an aromatic ring system. This ring system may be monocyclic, bicyclic or polycyclic. Examples of aryl groups are phenyl and naphthyl such as 1-naphthyl and 2-naphthyl, for example.

“C₆-C₂₀ aralkyl” denotes in the present context that the substituent is an alkyl which in turn is substituted by an aryl. Expressed otherwise, aralkyl describes an alkanediyl which is substituted by an aryl radical. A C₆-C₂₀ aralkyl is an aralkyl which contains 6 to 20 carbon atoms. The aryl radical may for example be an aryl as defined above. Examples of aralkyl are phenylmethyl (benzyl) or phenylethyl, for example.

In a further preferred embodiment, the at least one dicarboxylic acid derivative (component A3)) is selected from the group consisting of a dicarboxylic acid of the general formula (III) and a dicarboxylic ester of the general formula (IV).

The dicarboxylic acid (III) and the dicarboxylic ester (IV) are subject to the statements and preferences described above.

In another preferred embodiment the dicarboxylic acid (III) is selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid, 1,18-octadecanedioic acid, 1,3-cyclohexanedicarboxylic acid, 1,4-cyclohexanedicarboxylic acid, isophthalic acid, terephthalic acid, naphthalenedicarboxylic acid, C36-dimer acid, 2,5-tetrahydrofurandicarboxylic acid, 2,5-furandicarboxylic acid, monosodium 5-sulfoisophthalate, and monolithium 5-sulfoisophthalate.

In a further, especially preferred embodiment, the dicarboxylic acid (III) is selected from the group consisting of adipic acid (hexanedioic acid), pimelic acid (heptanedioic acid), suberic acid (octanedioic acid), azelaic acid (nonanedioic acid), sebacic acid (decanedioic acid), 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid, 1,18-octadecanedioic acid, 2,5-tetrahydrofurandicarboxylic acid, 1,3-cyclohexanedicarboxylic acid, 1,4-cyclohexanedicarboxylic acid, isophthalic acid, terephthalic acid, naphthalenedicarboxylic acid, and C36 dimer acid.

For the at least one endgroup regulator (component A5)), the statements and preferences described later on below for component C) are valid.

Polymerization from the reaction mixture (RM) may take place by any methods known to the skilled person. Polymerization takes place preferably at a reaction temperature T_{R} which is above the melting temperature T_{M} of the polyamide (P). The reaction temperature T_{R}, for example, is in the range from 190 to 235° C., preferably in the range from 195 to 230° C., and especially preferably in the range from 200 to 220° C.

The at least one polyamide (P) (component A)) generally has a viscosity number of 30 to 250 ml/g, preferably of 90 to 220 ml/g, and especially preferably in the range from 100 to 130 ml/g. The viscosity number is determined in a solution of 0.5 g of polyamide (P) in 100 ml of a 1:1 mixture of phenol and o-dichlorobenzene.

The weight-average molecular weight (M_{w}) of the at least one polyamide (P) is customarily in the range from 20 000 to 150 000 g/mol, preferably in the range from 30 000 to 140 000 g/mol, and especially preferably in the range from 35 000 to 120 000 g/mol, determined by means of gel permeation chromatography (GPC) (size exclusion chromatography (SEC)). Solvent used was hexafluoroisopropanol (HFIP).

The number-average molecular weight (Mₙ) is customarily in the range from 5000 to 75 000 g/mol, preferably in the range from 15 000 to 70 000 g/mol, and especially preferably in the range from 17 500 to 60 000 g/mol, determined by means of gel permeation chromatography (GPC) (size exclusion chromatography (SEC)). Solvent used was hexafluoroisopropanol (HFIP).

The melting temperature T_{M} of the at least one polyamide (P) is customarily in the range from 80 to 330° C., preferably in the range from 150 to 250° C., and especially preferably in the range from 180 to 230° C., determined by differential scanning calorimetry (DSC) or by dynamic mechanical thermoanalysis (DMTA) for semicrystalline polyamides. For amorphous polyamides, T_{M} is defined as the temperature at which the polyamide (P) (having a minimum solution viscosity of 80 mL/g to ISO307 in sulfuric acid) has at least a zero shear viscosity of 5000 Pa s and hence is processible in the melt (measured on a DHR-1 rotational rheometer from TA Instruments, plate/plate geometry, plate diameter 25 mm and sample height 1.0 mm. Deformation 1.0%, preheat time 1.5 min, and material dried under reduced pressure at 80° C. for 7 days beforehand).

The present invention therefore also provides a process wherein the melting temperature T_{M} of component A) is in the range from 80 to 330° C.

Component A) customarily has a glass transition temperature T_{G}. The glass transition temperature T_{G} of the at least one polyamide (P) (component A)) is customarily in the range from 0 to 150° C., preferably in the range from 20 to 100° C., and especially preferably in the range from 40 to 80° C., determined by DSC.

The present invention therefore also provides a process wherein the glass transition temperature T_{G} of component A) is in the range from 0 to 150° C.

Component B)

In accordance with the invention the melt (S) comprises at least one dienophile which comprises at least two dienophile units which are reactive toward the diene units present in component A).

“At least one dienophile” means in the context of the present invention not only exactly one dienophile but also a mixture of two or more dienophiles.

“At least two dienophile units which are reactive toward the diene units present in component A)” means that the at least one dienophile may contain exactly two dienophile units, or else may contain three or more dienophile units. Preferably in accordance with the invention, the at least one dienophile contains exactly two dienophile units which are reactive toward the diene units present in component A).

“Dienophile units which are reactive toward the diene units present in component A)” means that the dienophile units present in the dienophile are able to react with the diene units of component A) in a [4+2] cycloaddition. Groups of this kind and the corresponding dienophiles are known per se to the skilled person. The diene unit of component A) acts here as a diene component which contributes 4 t electrons to the [4+2] cycloaddition. The dienophile unit of the dienophile contributes 2 t electrons to the [4+2] cycloaddition.

Each diene unit of component A) therefore enters into a [4+2] cycloaddition with, respectively, one dienophile unit of component B).

The present invention accordingly also provides a process wherein in step ii) component A) reacts with component B) in a [4+2] cycloaddition to give the crosslinked polyamide (vP).

The at least two dienophile units present in component B) which are reactive toward the diene units (furan units) present in component A) are preferably selected independently of one another from the group consisting of C═C double bonds, C═O double bonds, and C═S double bonds.

The present invention accordingly also provides a process wherein the at least two diene units present in component B) are selected independently of one another from the group consisting of C═C double bonds, C═O double bonds, and C═S double bonds.

In one especially preferred embodiment the at least two dienophile units present in component B) are C═C double bonds.

In a further preferred embodiment, component B) comprises at least two dienophile units which are selected independently from the group consisting of C═C double bonds, C═O double bonds, and C═S double bonds, the double bonds containing electron-withdrawing substituents.

Electron-withdrawing substituents are known per se to the skilled person. Examples of electron-withdrawing substituents are carboxyl groups, ester groups, amides, nitriles, nitro groups, substituted aryls, fluoroalkyls, and fluorine, for example.

The skilled person is aware that the electron-withdrawing substituents increase the reactivity of the reactive groups of the dienophile toward the furan units.

In one especially preferred embodiment of the present invention, component B) comprises at least two structural units each selected from the group consisting of bismaleimide, benzophenone, acrylates, methacrylates, acrylonitriles, maleic acid, maleic anhydride, and maleic esters. Most preferably component B) comprises at least one polymer comprising at least two structural units each selected from the group consisting of bismaleimide, benzophenone, acrylates, methacrylates, acrylonitriles, maleic acid, maleic anhydride, and maleic esters.

A preferred bismaleimide is 4,4′-diphenylmethanebismaleimide.

The present invention accordingly also provides a process wherein component B) comprises at least two structural units each selected from the group consisting of bismaleimide, benzophenone, acrylates, methacrylates, acrylonitriles, maleic acid, maleic anhydride, and maleic esters.

Component C)

In one preferred embodiment the melt (S) comprises further, as component C), at least one endgroup regulator.

“At least one endgroup regulator” means in the context of the present invention both exactly one endgroup regulator and also a mixture of two or more endgroup regulators.

Endgroup regulators are known per se to the skilled person.

The idea is that the endgroup regulator reacts with the at least one polyamide (P), more particularly with the amine end groups of the at least one polyamide (P), and so transamidation in the melt (S) can be effectively prevented.

Examples of suitable endgroup regulators are monocarboxylic acids, monoamines, benzenemonocarboxylic acids, naphthalenemonocarboxylic acids, benzenemono-amines, naphthalenemonoamines, or diacids or anhydrides which form imides with amines.

Component C) is preferably selected from the group consisting of propionic acid, benzoic acid, naphthoic acid, and succinic anhydride.

The present invention therefore also provides a process wherein component C) is selected from the group consisting of propionic acid, benzoic acid, naphthoic acid, and succinic anhydride.

Component D)

In a further preferred embodiment of the invention, the melt (S) further comprises, as component D), at least one radical scavenger.

“At least one radical scavenger” is interpreted in accordance with the invention to refer both to exactly one radical scavenger and also to a mixture of two or more radical scavengers.

Radical scavengers are known to the skilled person. Examples of suitable radical scavengers are all substances which themselves are radicals and which through reaction with other radicals scavenge them, or substances which, in reactions with a radical, themselves form radicals which are stable.

Component D) is preferably selected from the group consisting of copper salts, aromatic amines, sterically hindered amines (HALS), sterically hindered phenols, phosphites, 2,2,6,6-tetramethylpiperidine-1-oxyl (TEMPO), and derivatives of 2,2,6,6-tetramethylpiperidine-1-oxyl (TEMPO). These compounds are known to the skilled person.

The present invention accordingly also provides a process wherein component D) is selected from the group consisting of copper salts, aromatic amines, sterically hindered amines (HALS), sterically hindered phenols, phosphites, 2,2,6,6-tetramethylpiperidine-1-oxyl (TEMPO), and derivatives of 2,2,6,6-tetramethylpiperidine-1-oxyl.

Step ii)

In step ii) the melt (S) is cooled to a second temperature T₂ which is below the melting temperature T_{M} of component A), to give the crosslinked polyamide (vP). In accordance with the invention the second temperature T₂ is lower than the first temperature T₁.

The second temperature T₂ is customarily at least 1° C. below the melting temperature T_{M} of component A), preferably at least 5° C., and especially preferably at least 10° C. below the melting temperature T_{M} of component A).

In one preferred embodiment component A) has a glass transition temperature T_{G} and the second temperature T₂ in step ii) is above the glass transition temperature T_{G} of component A).

The present invention accordingly also provides a process wherein component A) has a glass transition temperature T_{G} and the second temperature T₂ in step ii) is above the glass transition temperature T_{G} of component A).

Customarily the second temperature T₂ in this embodiment is at least 1° C., preferably at least 5° C., and especially preferably at least 10° C. above the glass transition temperature T_{G} of component A).

Preferably the second temperature T₂ in step ii) is in the range from 80 to 300° C., preferably in the range from 90 to 250° C., and especially preferably in the range from 100 to 180° C.

The present invention accordingly also provides a process wherein the second temperature T₂ in step ii) is in the range from 80 to 300° C., the second temperature T₂ being lower than the first temperature T₁.

It is self-evident that the first temperature T₁ in step i) is greater than the second temperature T₂ in step ii).

The present invention accordingly also provides a process wherein the first temperature T₁ in step i) is greater than the second temperature T₂ in step ii).

Any methods known to the skilled person are suitable for cooling the melt (S) to the second temperature T₂. For example, the melt (S) can be injection-molded and in that case can cool in the mold.

The cooling of the melt (S) in step ii) may take place within a certain time period. Preferably the cooling of the melt (S) takes place in a period in the range from 0.1 second to 5 minutes, especially preferably in the range from 0.5 second to 2 minutes, and most preferably in the range from 1 second to 1 minute.

The period of the cooling in step ii) is the time required to reach the second temperature T₂, starting from the first temperature T₁.

On cooling of the melt (S) to the second temperature T₂, the crosslinked polyamide (vP) is obtained.

The crosslinked polyamide (vP) is preferably obtained by the reaction of component A) with component B) in a [4+2] cycloaddition. [4+2] cycloadditions are known per se to the skilled person. They are also referred to as Diels-Alder reactions.

The present invention accordingly also provides a process wherein in step ii) component A) reacts with component B) in a [4+2] cycloaddition to give the crosslinked polyamide (vP).

In the [4+2] cycloaddition, the dienophile is added onto the furan unit (diene unit) by its dienophile units which are reactive toward the furan units present in component A), in other words preferably with the C═C double bond, the C═O double bond or the C═S double bond. As a result, a cyclohexene derivative is formed. This reaction is known per se to the skilled person.

After step ii) there may be a further step, step iii). In that case, customarily, the crosslinked polyamide (vP) is initially cooled to a third temperature T₃ which is below the glass transition temperature T_{G} of component A). Subsequently the crosslinked polyamide (vP) is heated to a fourth temperature T₄ which is above the glass transition temperature T_{G} of component A) and below the melting temperature T_{M} of component A). For the fourth temperature T₄, the statements and preferences which are valid are the same as for the second temperature T₂.

After step ii) and/or optionally after step iii), the crosslinked polyamide (vP) is customarily cooled to room temperature (20° C.).

Crosslinked Polyamide (vP)

Step ii) produces the crosslinked polyamide (vP). The crosslinked polyamide (vP) comprises structural units which can be derived from component A), component B), and also, optionally, components C) and D). It is self-evident that through the reaction of component A) with component B) in step ii), the diene units (furan units) present in the at least one polyamide (P) are at least partly modified. There are also changes in the structures of component B) and also, optionally, of components C) and D).

These reactions are known per se to the skilled person.

The weight-average molecular weight (M_{w}) of the crosslinked polyamide (vP) is customarily in the range from 40 000 to 300 000 g/mol, preferably in the range from 60 000 to 280 000 g/mol, and especially preferably in the range from 70 000 to 240 000 g/mol, determined by means of gel permeation chromatography (GPC) (size exclusion chromatography (SEC)). Solvent used was hexafluoroisopropanol (HFIP).

The number-average molecular weight (Mₙ) of the crosslinked polyamide (vP) is customarily in the range from 5000 to 75 000 g/mol, preferably in the range from 8000 to 70 000 g/mol, and especially preferably in the range from 10 000 to 60 000 g/mol, determined by means of gel permeation chromatography (GPC) (size exclusion chromatography (SEC)). Solvent used was hexafluoroisopropanol (HFIP).

The present invention also provides a crosslinked polyamide (vP) obtainable by the process of the invention.

The crosslinked polyamide (vP) produced in accordance with the invention may be used for example for producing moldings by injection molding processes, extrusion processes, 3-D prints, and rotational molding.

The process of the invention is illustrated hereinafter by examples, without being restricted thereto.

### EXAMPLES

In the examples the following components were used:
A) PA 6/F6 (80/20) (ω/w), copolymer of caprolactam (80 wt %) with 2,5-bis(aminomethyl)furan and adipic acid (together 20 wt %).
A′) PA 6 with a relative viscosity in 1% H₂SO₄ of 2.2 (Ultramid B22, BASF SE)
B1) Bis(maleimidophenyl)methane (CAS 13676-54-5)
B2) Bis(3-ethyl-5-methyl-4-maleimidophenylmethane) (CAS 105391-33-1)
B3) N,N′-1,3-bis(maleimido)benzene (CAS 3006-93-7)
C) Succinic anhydride (CAS 108-30-5)
D) 4-Hydroxy-TEMPO (2226-96-2)

Preparation of the Crosslinked Polyamides (VP)

The crosslinked polyamides (vP) were produced in a DSM miniextruder with conical twin screw and attached injection molding unit. For this purpose the melt, composed of component A) and/or A′) and also, optionally components B1), B2), B3), C), and D), was provided at 230° C. and mixed for 5 minutes. Thereafter tensile bars (type 1 according to ISO 37:2011 (E)) were produced by injection molding, the melt (S) having been cooled in accordance with step ii). The mold temperature (corresponding to the second temperature T₂), the extruder temperature (corresponding to the first temperature T₁), the pressure, and the duration are reported in table 1.

Characterization of the Crosslinked Polyamides (VP)

The properties reported in table 1 for the crosslinked polyamides (vP) were determined as follows:
weight-average molecular weight M_{w}; number-average molecular weight Mₙ: measured after filtration through Millipore Millex FG (0.2 μm) filters in hexafluoroisopropanol+0.05% potassium trifluoroacetate on a styrene-divinylbenzene column with PMMA standard from 0.8 kDa to 1820 kDa. Measurement at 35° C. with 1 mL/min flow rate and 1.5 mL/mg sample concentration
VN (viscosity number): 0.5 g/ml polymer was dissolved in phenol/ortho-dichlorobenzene (1:1) and then the viscosity number was determined (in accordance with ISO 307)
E-Modulus (modulus of elasticity): measured according to ISO 527-2 (2012)
Yield stress: measured according to ISO 527-2 (2012)
Yield strain: measured according to ISO 527-2 (2012)
Breaking stress: measured according to ISO 527-2 (2012)
Flow behavior (rheology): measured at 230° C. on a DHR-1 rotational rheometer from TA Instruments with plate/plate geometry (diameter 25 mm, height ˜1.0 mm-1.6 mm). Preheat time 1.5 min and 1.0% deformation in the frequency sweep and 10% deformation in the time sweep). The loss modulus and the storage modulus were determined. Prior to the measurement, the samples were dried under reduced pressure at 80° C. for 7 days.
tan δ: for the determination of the Tan δ (loss factor), the ratio of loss modulus to storage modulus was ascertained, the loss modulus and the storage modulus having been determined by means of rheology.

TABLE 1

| | V1 | 2 | 3 | 4 | 5 | V6 | 7 | 8 | V11 |
|---|---|---|---|---|---|---|---|---|---|
| A) | 98.3% | 97.3% | 96.3% | 94.3% | 92.3% | | 94.3% | 94.3% | 100% |
| A′) | | | | | | 94.3% | | | |
| B1) | | 1.0% | 2.0% | 4.0% | 6.0% | 4.0% | | | |
| B2) | | | | | | | 4.0% | | |
| B3) | | | | | | | | 4.0% | |
| C) | 1.0% | 1.0% | 1.0% | 1.0% | 1.0% | 1.0% | 1.0% | 1.0% | |
| D) | 0.7% | 0.7% | 0.7% | 0.7% | 0.7% | 0.7% | 0.7% | 0.7% | |
| VN | 58.1 | 73.3 | 81.4 | 86.3 | 87.9 | 113.5 | 95.2 | 105.1 | 98.2 |
| E-Modulus [MPa] | 2274 | 3153 | 3316 | 3237 | 3238 | 3026 | 3330 | 3336 | 2108 |
| Yield stress [MPa] | 70.96 | 93.54 | 96.19 | 95.33 | 95.03 | 85 | 97.47 | 96.15 | 73.46 |
| Yield strain [%] | 3.39 | 3.68 | 3.64 | 3.73 | 3.75 | 3.97 | 3.75 | 3.67 | 3.78 |
| Breaking stress [MPa] | 62.01 | 61.02 | 78.06 | 76.62 | 75.22 | 67.25 | 77.83 | 77.96 | 63.24 |
| M_{w} [g/mol] (GPC) | | | 88 000 | | | | | | 47 800 |
| Mₙ [g/mol] (GPC) | | | 12 300 | | | | | | 16 700 |
| tan δ [10 rad/s] after | 8.98 | 2.11 | 1.27 | 0.7 | | | | | 10.7 |
| 30 minutes | | | | | | | | | |
| Solubility of sample in 96% | yes | no | no | no | | | | | |
| H₂SO₄ after rheology | | | | | | | | | |
| measurement. (30 min, | | | | | | | | | |
| 210° C.) (T(H₂SO₄) = 23° C.) | | | | | | | | | |
| Solubility of sample in 96% | yes | yes | yes | yes | | | | | |
| H₂SO₄ after rheology. (30 min, | | | | | | | | | |
| 210° C.) (T(H₂SO₄) = 100° C.) | | | | | | | | | |
| Injection molding: | | | | | | | | | |
| Mold temperature [° C.] | 60 | 55 | 55 | 55 | 55 | 55 | 55 | 55 | 55 |
| Extruder temperature [° C.] | 230 | 230 | 230 | 230 | 230 | 230 | 230 | 230 | 230 |
| Pressure [bar] | 8 | 10 | 10 | 12 | 12 | 9 | 12 | 12 | 12 |
| Duration [s] | 9 | 9 | 9 | 9 | 9 | 9 | 9 | 9 | 9 |

The crosslinked polyamides (vP) produced in accordance with the invention are notable for particularly high modulus of elasticity, particularly high yield stress, high breaking stress, high yield strain, and reduced solubility in sulfuric acid.

1. A process for preparing a crosslinked polyamide (vP), comprising the steps of
i) providing a melt (S) which comprises components
A) at least one polyamide (P) having a melting temperature T_{M} and comprising diene units of the general formula (I) 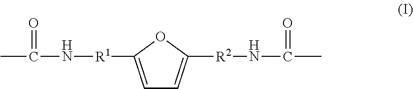
in which
R¹ and R² independently of one another are selected from C₁-C₁₀ alkanediyl,
B) at least one dienophile which comprises at least two dienophile units which are reactive toward the diene units present in component A),
at a first temperature T₁ which is above the melting temperature T_{M} of component A),
ii) cooling the melt (S) to a second temperature T₂ which is below the melting temperature T_{M} of component A), to give the crosslinked polyamide (vP).

2. The process according to claim 1, wherein component A) reacts with component B) in step ii) in a [4+2]-cycloaddition to give the crosslinked polyamide (vP).

3. The process according to claim 1, wherein component A) has a glass transition temperature T_{G} and the second temperature T₂ in step ii) is above the glass transition temperature T_{G} of component A).

4. The process according to claim 1, wherein the first temperature T₁ in step i) is in the range from 90 to 380° C.

5. The process according to claim 1, wherein the second temperature T₂ in step ii) is in the range from 80 to 300° C., the second temperature T₂ being lower than the first temperature T₁.

6. The process according to claim 3, wherein the glass transition temperature T_{G} of component A) is in the range from 0 to 150° C.

7. The process according to claim 1, wherein the melting temperature T_{M} of component A) is in the range from 80 to 330° C.

8. The process according to claim 1, wherein the at least two diene units present in component B) are selected independently of one another from the group consisting of C═C double bonds, C═O double bonds, and C═S double bonds.

9. The process according to claim 1, wherein component B) comprises at least two structural units each selected from the group consisting of bismaleimide, benzophenone, acrylates, methacrylates, acrylonitriles, maleic acid, maleic anhydride, and maleic esters.

10. The process according to claim 1, wherein the melt (S) additionally comprises as component C) in the range from 0 to 2 wt % of at least one endgroup regulator, based on the sum of the wt % of the components A), B), and C) present in the melt (S).

11. The process according to claim 10, wherein component C) is selected from the group consisting of propionic acid, benzoic acid, naphthoic acid, and succinic anhydride.

12. The process according to claim 1, wherein the melt (S) additionally comprises as component D) in the range from 0.5 to 5 wt % of at least one radical scavenger, based on the total weight of the components A), B), C), and D) present in the melt (S).

13. The process according to claim 12, wherein component D) is selected from the group consisting of copper salts, aromatic amines, sterically hindered amines (HALS), sterically hindered phenols, phosphites, 2,2,6,6-tetramethylpiperidine-1-oxyl (TEMPO), and derivatives of 2,2,6,6-tetramethylpiperidine-1-oxyl.

14. The process according to claim 1, wherein the melt (S) comprises the following components:
A) from 83 to 99 wt % of component A),
B) from 0.5 to 10 wt % of component B),
C) from 0 to 2 wt % of at least one endgroup regulator,
D) from 0.1 to 5 wt % of at least one radical scavenger,
based in each case on the sum of the wt % of the components A) to D) present in the melt (S).

15. A crosslinked polyamide (vP) obtainable by a process of claim 1.
